(19) United States
(12) Patent Application Publication
(10) Pub. No.: US 2026/0235784 A1
(43) Pub. Date: Aug. 13, 2026

(54) APODIZED OPTICAL WINDOW

(71) Applicant: Quantinuum LLC, Broomfield, CO (US)

(72) Inventors: Adam Jay OLLANIK, Boulder, CO (US); Christopher T. ERTSGAARD, Champlin, MN (US); David M. GAUDIOSI, Loveland, CO (US); Bruce Gregory TIEMANN, Longmont, CO (US)

(21) Appl. No.: 19/533,555

(22) Filed: Feb. 9, 2026

Related U.S. Application Data
(60) Provisional application No. 63/757,566, filed on Feb. 12, 2025.

(51) Int. Cl. G02B 1/00

(52) U.S. Cl. CPC G02B 1/00

(57) ABSTRACT

An optical window is defined within a non-transparent surface. The optical window includes a transition region defined proximate the perimeter of the optical window. At least one optical property of the optical window evolves across the transition region. The opacity of the optical window at the perimeter is substantially equal to 100 percent. The optical window may be configured for an optical beam transmitted therethrough to interact with a confined atomic or quantum object. In various embodiments, methods of fabricating an optical window and systems including an optical window are provided.

### CROSS-REFERENCE TO RELATED APPLICATION(S)

This application claims priority to U.S. Application No. 63/757,566, filed Feb. 12, 2025, the content of which is incorporated herein by reference.

### TECHNICAL FIELD

Various embodiments relate to an optical window through a non-transparent surface or structure that is apodized. Various embodiments relate to an optical window through a non-transparent surface or structure that has an optical transmission property that evolves over a transition region of the optical window.

### BACKGROUND

In various systems, an optical beam may be provided through an optical window formed in a non-transparent surface or structure. For example, an optically opaque coating may be applied to an external surface of a photonic integrated circuit (PIC) and an optical window may be formed through the optically opaque coating to enable optical beams to pass into/out of the PIC. However, the edges of the optical window may cause diffractive effects in the optical beams that pass there through. Through applied effort, ingenuity, and innovation many deficiencies of such prior optical windows have been solved by developing solutions that are structured in accordance with the embodiments of the present invention, many examples of which are described in detail herein.

### BRIEF SUMMARY OF SOME EXAMPLE EMBODIMENTS

Various embodiments provide optical windows formed in and/or through non-transparent and/or optically opaque surfaces or structures that are apodized. For example, at least one optical transmission property of an optical window may evolve or change within a transition region of the optical window such that diffractive effects caused by an optical beam interacting with the optical window (e.g., edges of the optical window) are reduced and/or prevented. In various embodiments, the transition region is disposed proximate and/or adjacent to a perimeter of the optical window and has a width in a plane of the optical window that is larger than a wavelength that characterizes an optical beam that the optical window is configured to transmit through the optical window.

According to one aspect, an optical window is defined within a non-transparent surface. The optical window includes a transition region defined proximate the perimeter of the optical window, wherein at least one optical property of the optical window evolves across the transition region, wherein the opacity of the optical window at the perimeter is substantially equal to 100 percent.

In certain embodiments, the optical window is configured for an optical beam transmitted therethrough to interact with a confined atomic or quantum object.

In an example embodiment, the transition region is defined by an outer boundary that defines the perimeter of the optical window and an inner boundary located within the optical window, wherein at least one optical transmission property of the optical window evolves from the inner boundary to the outer boundary.

In an example embodiment, the at least one optical transmission property of the optical window evolves as a function of location between the inner boundary and the outer boundary.

In an example embodiment, the at least one optical transmission property is opacity and the opacity of the optical window at the inner boundary is a minimal opacity that is less than 100 percent.

In an example embodiment, the optical window comprises a sawtooth edge that comprises generally triangular-shaped segments of non-transparent material having a broad end located at the outer boundary and that extend from the broad end to a tip located between the outer boundary and the inner boundary or at the inner boundary.

In an example embodiment, a patterned binary deposition of non-transparent material is present on the optical window between the inner boundary and the outer boundary and the patterned binary deposition of non-transparent material is configured such that local fill fraction of non-transparent material increases from the inner boundary to the outer boundary.

In an example embodiment, the optical window between the inner boundary and the outer boundary is virtually divided into unit cells, each unit cell is assigned a respective fill fraction as a function of a location of the unit cell between the inner boundary and the outer boundary, and each unit cell is filled with a non-transparent material in accordance with the respective fill fraction.

In an example embodiment, the respective fill fraction increases from 0 at the inner boundary to 1 at the outer boundary.

In an example embodiment, the optical window further includes a film disposed at least between the inner boundary and the outer boundary, the film having a minimum thickness at the inner boundary and a maximum thickness at the outer boundary.

In an example embodiment, the opacity of the film increases as the thickness of the film increases.

In an example embodiment, the inner boundary is defined by a distance from a center of the optical window that is greater than zero.

In an example embodiment, a portion of the optical window disposed within the inner boundary is characterized by the minimal opacity.

In an example embodiment, the at least one optical transmission property is an angle of deflection of an optical beam propagating through the optical window.

In an example embodiment, the optical window further includes a metasurface disposed within the transition region, wherein the metasurface controls the change in the at least one optical property.

In an example embodiment, the non-transparent layer is a non-transparent coating on an exterior of a photonic integrated circuit (PIC) or a surface of an electrode.

In an example embodiment, the transition region has a width in a plane defined by the optical window that is larger than a wavelength that characterizes an optical signal that the optical window is configured transmit therethrough.

According to another aspect, a method for fabricating an optical window in a non-transparent surface is provided. In an example embodiment the method includes forming one or more optical features on the optical window within a transition region disposed proximate a perimeter of the optical window, wherein the optical opacity of the optical window at the perimeter is substantially equal to 100%. The one or more optical features are configured to cause at least one optical transmission property of the optical window to evolve across the transition region.

In an example embodiment, the one or more optical features are formed using at least one of lithographic etching, lift-off deposition, sputtering, direct-write etching, or grey scale lithography.

In an example embodiment, forming the one or more optical features includes depositing a film between an inner boundary of the optical window and the outer boundary of the optical window, wherein the outer boundary of the optical window is defined by the perimeter of the optical window, the inner boundary is disposed within the optical window, and the opacity of the optical window at the inner boundary is a minimal opacity that is less than 100 percent.

In an example embodiment, forming the one or more optical features includes using greyscale lithography to pattern the film such that the film has a minimum thickness at the inner boundary and a maximum thickness at the outer boundary, wherein the opacity of the film increases within increasing thickness of the film.

In an example embodiment, forming the one or more optical features includes patterning a sawtooth edge that comprises generally triangular-shaped segments of non-transparent material having a broad end located at an outer boundary of the optical window and that extend from the broad end to a tip located between the outer boundary and an inner boundary of the optical window or at the inner boundary, wherein the outer boundary of the optical window is defined by the perimeter of the optical window, the inner boundary is disposed within the optical window, and the opacity of the optical window at the inner boundary is a minimal opacity that is less than 100 percent.

In an example embodiment, forming the one or more optical features includes patterning non-transparent material to fill a plurality of unit cells virtually defined within the transition region with respective fill fractions of non-transparent material, wherein the respective fill fractions are assigned to the plurality of unit cells as a function of locations of respective unit cells of the plurality of unit cells within the transition region.

In an example embodiment, the one or more features form a metasurface within the transition region and the metasurface controls the evolution of the at least one optical transmission property.

According to another aspect, a system including an optical window is provided. In an example embodiment, the system includes a manipulation source configured to generate an optical beam; an atomic or quantum object confinement apparatus defining a target location; and a beam path system comprising at least one optical window of an example embodiment.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 provides a schematic diagram of an example optical window formed through a non-transparent surface, according to an example embodiment.

FIG. 2 provides a schematic diagram of an example optical window having a sawtooth edge within a transition region thereof, according to an example embodiment.

FIG. 3 provides a schematic diagram of a portion of an example optical window having a plurality of virtually defined unit cells within a transition region of the optical window that are each filled with non-transparent material to a respective fill fraction, according to an example embodiment.

FIG. 4 provides a schematic diagram of a portion of an example optical window having an array of metastructures formed in a transition region of the optical window, according to an example embodiment.

FIG. 5 provides a flowchart illustrating various processes, procedures, operations, and/or the like that may be performed to fabricate an optical window, according to an example embodiment.

FIG. 6 provides a schematic diagram of an example QCCD-based quantum computer system that includes an optical window, in accordance with an example embodiment.

FIG. 7 provides a schematic diagram of an example controller that may be used in accordance with an example embodiment.

FIG. 8 provides a schematic diagram of an example computing entity that may be used in accordance with an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally” and “approximately” refer to within engineering and/or manufacturing limits and/or within user measurement capabilities, unless otherwise indicated. Like numbers refer to like elements throughout.

In various systems, an optical beam may be delivered to a target location through an optical window defined and/or formed in a non-transparent or optically opaque surface of structure. For example, in various systems, such as atomic systems or quantum systems, optical beams may be provided to target locations to interact with quantum and/or atomic objects. In an example atomic or quantum system, optical beams may be provided via a photonic integrated circuit (PIC) that has an optically opaque coating on one or more external surfaces of the substrate hosting the PIC. In another example, an optical beam may be provided through an optical window formed in an electrode of an ion trap or atomic/quantum object confinement apparatus that includes integrated photonics.

As an optical beam is transmitted through the optical window, the optical beam interacts with the edges of the optical window. This results in diffraction effects being present in the transmitted optical beam. In systems it is important to be able to precisely and accurately, in terms of position, spacings, mode profile, polarization, frequency, and/or phase, deliver one or more optical beams to target locations. For example, in atomic systems such as atomic clocks, Bose-Einstein condensate systems, trapped ion systems, QCCD-based quantum computers, and/or other atomic and/or quantum systems, precise and accurate laser beam delivery is important for various uses of the system, manipulating the system, and/or the like. However, the diffraction effects caused by the optical beam interacting with the edge of the optical window may introduce sufficient noise in the optical beam so as to degrade the fidelity of operations performed using the optical beam. Therefore, technical problems exist regarding providing an optical beam through an optical window. For example, technical challenges exist regarding providing an optical beam through an optical window for high fidelity atomic and/or quantum object interaction.

Various embodiments provide technical solutions to these technical problems. For example, in various embodiments, the edge of the optical window is apodized so as to reduce or prevent the presence of diffraction effects in optical beams that are transmitted through the optical window. In certain embodiments, an optical window is formed and/or defined in a non-transparent and/or optical opaque surface or structure (generally referred to as a non-transparent surface herein). A transition region of the optical window extends from an inner boundary disposed within the optical window and an outer boundary that is defined by and/or disposed at the boundary of the optical window. For example, at the perimeter of the optical window, the optical opacity of the optical window is substantially equal 100 percent. At least one optical transmission property of the optical window evolves across the transition region. For example, the opacity and/or transmissivity of the optical window may evolve across the transition region. In another example, an angle of deflection, polarization effect, relative phase delay, focus/divergence effect of the optical window on an optical beam passing through the window may evolve across the transition region. In various embodiments, the width of the transition region, in a plane of the optical window, is larger (possibly much much larger) than a wavelength that characterizes an optical beam that the optical window is configured to transmit there through. For example, in an embodiment where the optical beam to be transmitted through the optical window is characterized by 600 nm, the width of the transition region of the optical window is larger than 600 nm (e.g., 610 nm-1 micron). As a result, the optical beam being transmitted through the optical window does not experience the perimeter of the optical window as a hard edge and the diffractive effects are prevented and/or are not generated. Thus various embodiments provide technical improvements to the field of providing optical beams through optical windows with a high level of control over the optical properties of the optical beam, providing an optical beam through an optical window for high fidelity atomic and/or quantum object interaction, and/or systems that include optical windows.

### Example Optical Window

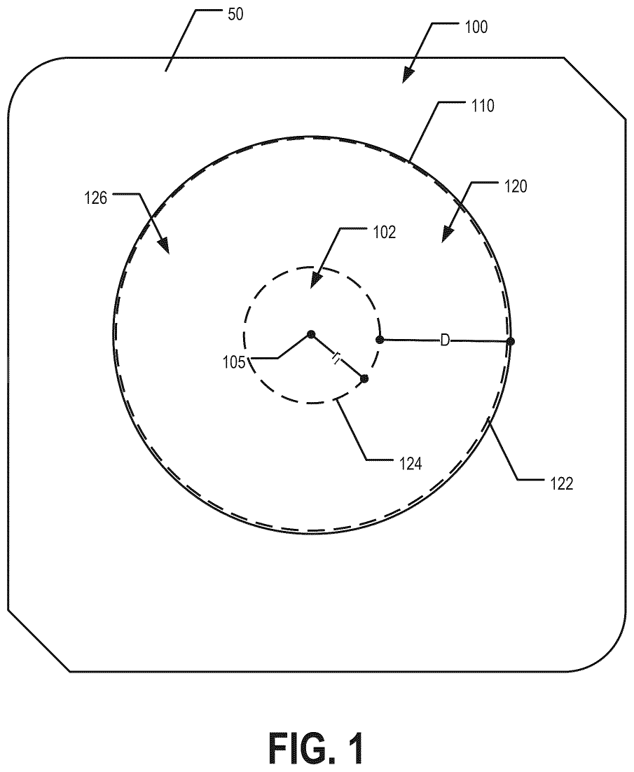

FIG. 1 provides a schematic diagram of an example optical window 100. In various embodiments, the optical window 100 is disposed, formed, and/or defined in a non-transparent and/or opaque surface 50. For example, the non-transparent surface 50 may be a non-transparent and/or opaque coating disposed on one or more surfaces of a photonic integrated circuit (PIC), such as in U.S. application Ser. No. 18/610,803, filed Mar. 20, 2024, the content of which is incorporated by reference herein in its entirety. In another example, the non-transparent surface 50 may be an electrode of a confinement apparatus, ion trap, or other device. For example, the optical window 100 may be the exposed surface of a window cap as disclosed in U.S. Application No. 63/562,324, filed Mar. 7, 2024, the content of which is incorporated herein by reference in its entirety. While the optical window 100 is illustrated as being round or circular in FIG. 1, optical windows 100 of various embodiments may have a variety of shapes in the plane defined by the non-transparent surface (e.g., oval, rectangular, polygonal, irregular, and/or the like) as appropriate for the application.

The optical window 100 is defined by a perimeter 110. For example, at the perimeter 110, the opacity of the optical window 100 is 100%. Within the perimeter 110, the opacity is less than 100% at least for a wavelength range that includes a wavelength that characterizes an optical beam that the optical window 100 is configured to transmit therethrough.

A transition region 120 extends from an inner boundary 124 to an outer boundary 122 of the optical window 100. The outer boundary 122 is defined and/or coincident with the perimeter 110 of the optical window 100. In FIG. 1, the outer boundary 122 is shown as being just inside the perimeter 110, so that the outer boundary 122 is visible. However, the outer boundary 122 is generally aligned and/or defined by the perimeter 110.

In various embodiments, the transition region 120 has a width D in a plane of the optical window 100 and/or the plane of the non-transparent surface 50. For example, the distance between the inner boundary 124 and the outer boundary 122 is the width D. In various embodiments, the width D is larger than a wavelength that characterizes an optical beam that the optical window 100 is configured to transmit therethrough. For example, for an optical window 100 configured to transmit an optical beam there through that is characterized by a wavelength λ, the width D is larger than the wavelength λ (e.g., D>λ). In some embodiments, the width D is much larger than the wavelength λ. For example, the width D may be at least 5 times the wavelength λ (e.g., D>5 λ), at least 10 times the wavelength λ (e.g., D>10 λ), and/or larger.

In various embodiments, the inner boundary 124 is located an inner boundary distance r_{I} from a center point 105 of the optical window 100. In various embodiments, the inner boundary distance r_{I} is greater than zero. In certain embodiments, the inner boundary distance r_{I} is equal to zero. In various embodiments, at the inner boundary 124, the optical window 100 is characterized by a minimal opacity, which is an opacity that is less than 100%. In some embodiments, the minimal opacity is an opacity that is 50% or less. In certain embodiments, the minimal opacity is an opacity that is 25% or less. In an example embodiment, the minimal opacity is an opacity that is less than 10% or approximately 0%. As used herein, the terms opacity and transmissivity corresponds to a range of wavelengths that includes a wavelength λ that characterizes an optical beam that the optical window is configured to transmit there through.

In various embodiments, at least one optical transmission property of the optical window 100 changes or evolves over the transition region 120. For example, at least one optical transmission property of the optical window 100 is different at the inner boundary 124 than at the outer boundary 122. In an example embodiment, the evolution of the at least one optical transmission property of the optical window 100 is smooth, monotonic, and/or continuous across the transition region 120.

In various embodiments, the at least one optical transmission property of the optical window 100 that changes or evolves over the transition region 120 is at least one of opacity, transmissivity, angle of deflection, polarization, relative phase delay, focusing, divergence, and/or another optical transmission property. For example, in some embodiments, the opacity of the optical window increases from the minimal opacity at the inner boundary 124 to 100% opacity at the outer boundary 122. In some embodiments, the transmissivity of the optical window decreases from a maximum transmissivity at the inner boundary 124 to 0% transmissivity at the outer boundary 122. In various embodiments, an angle of deflection imparted to a portion of an optical beam passing through the transmission region may vary or evolve across the transition region 120. In various embodiments, the effect of the optical window 100 on the polarization of a portion of an optical beam passing through the transmission region may vary or evolve across the transition region 120. In certain embodiments, a relative phase delay imparted to a portion of an optical beam passing through the transmission region may vary or evolve across the transition region 120. In some embodiments, the optical window 100 may be characterized by a focal length that evolves across the transition region 120.

In various embodiments, the at least one optical transmission property of the optical window 100 is a function of location within the transition region 120 and is substantially not a function of location in a portion 102 of the optical window 100 disposed within the inner boundary 124. For example, for a position on the optical window 100 within the transition region 120, the at least one optical transmission property is a function and/or is determined based on a distance of the position from the center point 105 of the optical window 100, on a distance of the position from the inner boundary 124, and/or on a distance of the position from the outer boundary 122.

In an example embodiment, the transition region 120 comprises one or more features 126. The presence of the one or more features 126 within the transition region 120 cause the evolution of the at least one optical transmission property. For example, in some embodiments, the one or more features 126 are a film or deposition(s) of a material that effects the at least one optical transmission property. In certain embodiments, the one of more features 126 are an array of metastructures that form a metasurface within the transition region 120.

In certain embodiments, the one or more features 126 are a patterned binary deposition. In other words, the transition region 120 may include a patterned binary deposition of non-transparent material such that in a plurality of non-transparent areas within the transition region 120, the non-transparent material is present and in a plurality of transparent areas within the transition region, the non-transparent material is not present. For example, the patterned binary deposition includes non-transparent material of a uniform thickness (e.g., in a range of 10 nm to 10 microns depending on the material and/or optical properties of the non-transparent material) in non-transparent areas (areas where the non-transparent material is present). As a result the opacity of the optical window in the non-transparent areas is 100% opacity and the opacity of the optical window at the transparent areas (e.g., areas where the non-transparent material is not present) is the minimal opacity. The patterned binary deposition is patterned such that the effective opacity or other optical transmission property of the optical window evolves across the transition region 120. For example, the patterned binary deposition is configured such that the fill-fraction (of non-transparent material) within a local region, which determines the effective optical opacity within the local region, varies across the transition region 120. For example, the patterned binary deposition is configured such that the effective opacity increases adiabatically from the inner boundary 124 (e.g., the minimal opacity) to the outer boundary 122 (100% opacity), in certain embodiments.

One example patterned binary deposition includes a film of non-transparent material that is deposited on the transition region 120 and then etched or otherwise patterned to include holes through the film of non-transparent material. The density of holes is increases from a minimum density at the outer boundary 122 to a maximum density at the inner boundary 124. For example, the density of holes through the non-transparent material at the outer boundary 122 is low such that the opacity of the optical window at the outer boundary 122 is 100% and the density of holes through the non-transparent material at the inner boundary 124 is high such that the opacity of the optical window at the inner boundary 124 is the minimal opacity.

Another example binary patterned deposition includes dots of film of non-transparent material that are deposited on the transition region 120. The density of dots of film is increases from a minimum density at the inner boundary 124 to a maximum density at the outer boundary 122. For example, the density of dots of holes through the non-transparent material at the outer boundary 122 is high such that the opacity of the optical window at the outer boundary 122 is 100% and the density of holes through the non-transparent material at the inner boundary 124 is low such that the opacity of the optical window at the inner boundary 124 is the minimal opacity.

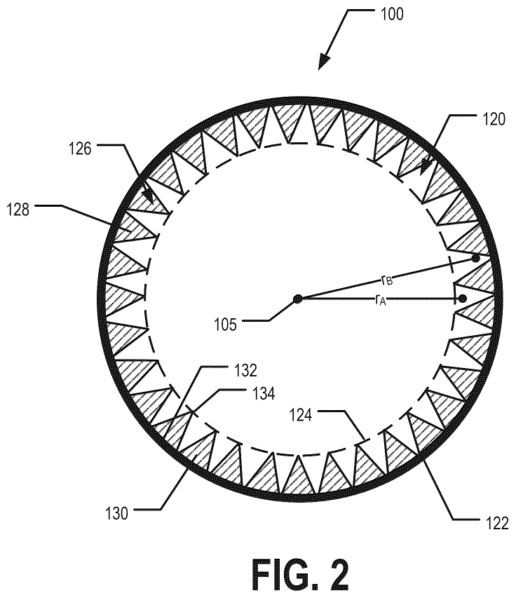

Another example binary patterned deposition is a sawtooth edge. FIG. 2 illustrates an example embodiment where the at least one optical transmission property that evolves across the transition region 120 is opacity and/or transmissivity as a result of a binary patterned deposition in the form of a sawtooth edge. The one or more features 126 are a patterned deposition of a non-transparent material. In various embodiments, the non-transparent material may be the same material as the non-transparent surface 50 or a different non-transparent and/or opaque material. In the example embodiment illustrated in FIG. 2, the one or more features 126 are non-transparent material that has been patterned into a sawtooth edge. The sawtooth edge comprises generally triangular-shaped segments 130 of non-transparent material 128 having a broad end 132 located at the outer boundary 122 and that extend from the broad end 132 to a tip or narrow end 134 located either between the outer boundary 122 and the inner boundary 124 or at the inner boundary 124. In various embodiments, the broad end is broader than the narrow end. For example, the narrow end may be a point, rounded point, and/or the like.

For a ring within the transition region 120 where all points on the ring are equidistant from the center point 105 of the window, the coverage of the ring by non-transparent material is a function of the distance of the points on the ring from the center point 105. For example, a ring of points characterized by a first radius r_{A} has a first coverage by the non-transparent material 128 and a ring of points characterized by a second radius r_{B} has a second coverage of the non-transparent material 128. The first radius r_{A} is less than the second radius r_{B} and the first coverage is less than the second coverage. For example, the coverage of the non-transparent material 128 increases from 0% or nearly 0% at the inner boundary 124 to 100% at the outer boundary 122. As a result, the opacity of the optical window evolves across the transition region 120 from a minimal opacity at the inner boundary 124 to 100% at the outer boundary 122.

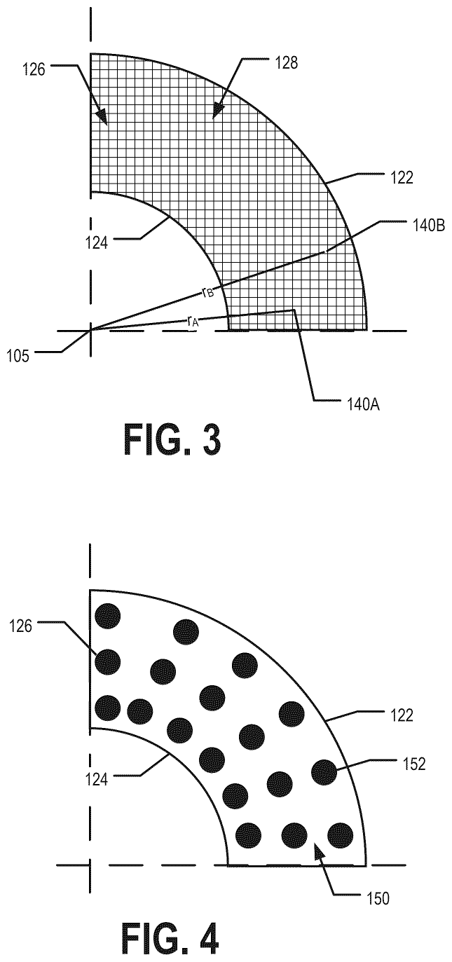

FIG. 3 illustrates another example where the at least one optical transmission property that evolves across the transition region is opacity and/or transmissivity as a result of a binary patterned deposition. For example, the transition region 120 (of which only a portion is shown in FIG. 3) is (virtually) divided into unit cells 140 (e.g., 140A, 140B). Each unit cell 140 is assigned a respective fill fraction and non-transparent material is patterned onto the optical window 100 such that each unit cell 140 is filled with a respective fill fraction of non-transparent material. For example, the one or more features 126 may be a patterned deposition of non-transparent material 128. In various embodiments, the non-transparent material may be the same material as the non-transparent surface 50 or a different non-transparent and/or opaque material. In various embodiments, the fill fraction assigned to a unit cell 140 is a function of the distance of the unit cell from the center point 105 of the optical window 100, on a distance of the unit cell 140 from the inner boundary 124, and/or on a distance of the unit cell 140 from the outer boundary 122. For example, in certain embodiments, each unit cell 140 is assigned a respective fill fraction as a function of a location of the unit cell 140 between the inner boundary 124 and the outer boundary 122, and each unit cell 140 is filled with a non-transparent material 128 in accordance with the respective fill fraction.

For example, a first unit cell 140A is a first radius r_{A} from the center point 105 and is assigned a first fill fraction. A second unit cell 140B is a second radius r_{B} from the center point 105 and is assigned a second fill fraction. The first radius r_{A} is less than the second radius r_{B} and the first fill fraction is less than the second fill fraction. For example, the coverage of the non-transparent material 128 increases from 0% or nearly 0% at the inner boundary 124 to 100% at the outer boundary 122. For example, the respective fill fraction increases from 0 at the inner boundary 124 to 1 at the outer boundary 122. As a result, the opacity of the optical window evolves across the transition region 120 from a minimal opacity at the inner boundary 124 to 100% opacity at the outer boundary 122.

FIG. 4 illustrates a portion of an optical window 100 of an example embodiment where the one or more features 126 are an array of a plurality of metastructures 152. The array of the plurality of metastructures 152 forms a metasurface 150. In various embodiments, the metasurface 150 is configured to control the angle of deflection, polarization, relative phase delay, focusing, divergence, and/or another optical transmission property of the optical window within the transition region 120. For example, the metasurface 150 may be configured and/or designed to cause at least one optical property of the optical window 100 to evolve across the transition region.

In another example embodiment, a film may be deposited and patterned (e.g., via grey scale lithography) such that the thickness of the film evolves over the transition region 120. For example, at the inner boundary 124 the film may have a minimum thickness (e.g., approximately zero) in a direction normal to a surface of the optical window (e.g., out of the page in FIG. 1) and a maximum thickness (e.g., in a range of 10 nm to 10 microns depending on the material and/or optical properties of the film) at the outer boundary 122. In other words, the film may be thinner at the inner boundary 124 than at the outer boundary 122. For example, the thickness of the film may increase from the minimum thickness at the inner boundary 124 to the maximum thickness at the outer boundary 122. In various embodiments, the film may affect the at least one optical transmission property as a function of thickness of the film. For example, an angle of deflection imparted to a portion of an optical beam passing through the transition region may be a function of the thickness of the film the portion of the optical beam passes through. In another example, the opacity of the film may be a function of the thickness of the film such that the opacity of the film is low (e.g., the minimal opacity) when the film is thin, such as at the inner boundary 124, and the opacity of the film is high (e.g., substantially equal to 100% opacity) when the film is thick, such as at the outer boundary 122.

As a result of evolution of the at least one optical transmission property across the transition region 120, the perimeter 110 of the optical window 100 does not cause diffraction effects to be present in an optical beam that pass through the optical window 100.

### Example Method of Fabricating an Optical Window

Various embodiments provide methods for fabricating an optical window 100. For example, an optical window 100 may be formed and/or defined in a non-transparent surface 50. One or more features may be formed or fabricated on the optical window 100 (e.g., within the transition region 120). In some embodiments, the one or more features are formed in the same process that defines the optical window 100 in the non-transparent surface 50. In some embodiments, the optical window 100 is formed or defined in the non-transparent surface 50 and, in a separate process, the one or more features are formed or fabricated in the transition region 120. In various embodiments, the one or more features are formed using one or more of lithographic etching or liftoff-deposition, grey scale lithography, direct-write etching methods such as focused ion beam (FIB) or laser processing, and/or the like.

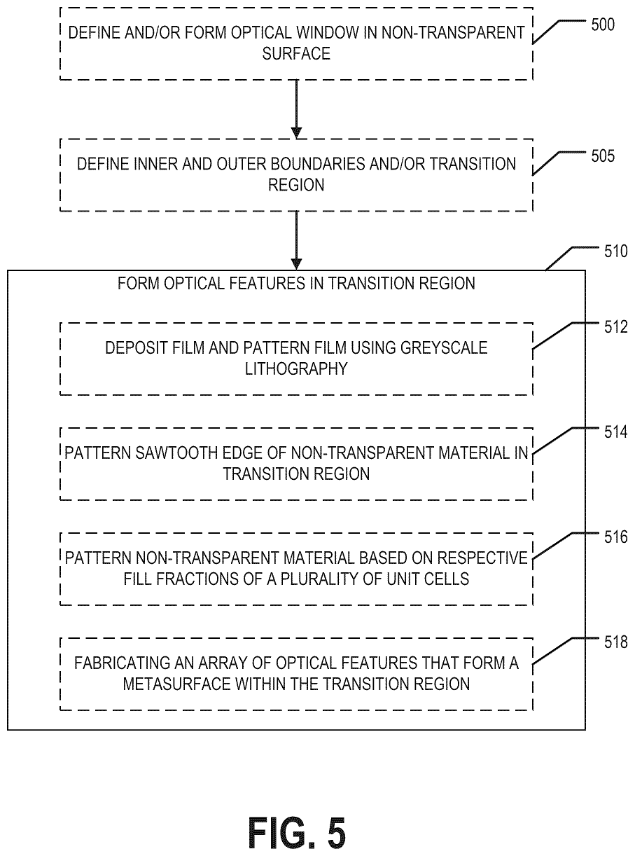

FIG. 5 provides a flowchart illustrating various processes, procedures, operations, and/or the like for fabricating an optical window of an example embodiment. Starting at block 500, the optical window 100 is formed and/or defined in the non-transparent surface 50. For example, the optically transparent material of the optical window 100 may be deposited in an opening in the non-transparent surface 50 (see, for example, U.S. Application No. 63/562,324, filed Mar. 7, 2024), the optical window 100 may be etched through the non-transparent surface 50 (see, for example, U.S. application Ser. No. 18/610,803, filed Mar. 20, 2024), and/or the like.

At block 505, the inner boundary 124, outer boundary 122, and/or transition region 120 is defined. For example, the portions of the optical window 100 to be used as the transition region 120 is identified, determined, and/or selected. In various embodiments, the transition region 120, inner boundary 124, and/or outer boundary 122 are determined based on one or more properties of an optical beam that the optical window 100 is configured to transmit (e.g., a wavelength that characterizes the optical beam, a full width half maximum (FWHM) or other measure of the width of the optical beam, and/or the like). For example, the transition region 120, inner boundary 124, and/or outer boundary 122 is determined and/or defined such that the width D of the optical window is larger than a wavelength λ that characterizes an optical beam that the optical window is configured to transmit therethrough.

At block 510, the one or more features are formed. In various embodiments, the one or more features 126 are formed in the transition region 120. In various embodiments, the one or more optical features are configured to cause at least one optical transmission property of the optical window to evolve across the transition region. For example, the one or more features 126 may be formed in the transition region using lithographic etching, lithographic liftoff-deposition, grey scale lithography, sputtering, one or more direct-write etching methods, and/or the like.

For example, at block 512, a film may be deposited at least on the transition region 120 and then patterned using greyscale lithography. For example, the film may be patterned such that, at the inner boundary 124, the thickness of the film is a minimum thickness (e.g., approximately zero) in a direction normal to a surface of the optical window (e.g., out of the page in FIG. 1) and a maximum thickness (e.g., in a range of 10 nm to 10 microns depending on the material and/or optical properties of the film) at the outer boundary 122. In other words, the film may be patterned using greyscale lithography and/or the like to be thinner at the inner boundary 124 than at the outer boundary 122. For example, the thickness of the film may increase from the minimum thickness at the inner boundary 124 to the maximum thickness at the outer boundary 122. In various embodiments, the film may be configured to affect the at least one optical transmission property as a function of thickness of the film. For example, an angle of deflection imparted to a portion of an optical beam passing through the transition region may be a function of the thickness of the film the portion of the optical beam passes through. In another example, the opacity of the film may be a function of the thickness of the film such that the opacity of the film is low (e.g., the minimal opacity) when the film is thin, such as at the inner boundary 124, and the opacity of the film is high (e.g., substantially equal to 100% opacity) when the film is thick, such as at the outer boundary 122.

In another example, at block 514, a sawtooth boundary or other patterned boundary may be fabricated within the transition region 120. For example, non-transparent material 128 may be deposited onto the optical window 100 and/or transition region 120 and then patterned (e.g., via lithographic etching, lithographic liftoff-deposition, one or more direct-write etching methods, and/or the like) to form a sawtooth boundary having a broad end 132 at the outer boundary and a tip and/or narrow end 134 at the inner boundary 124 or between the inner boundary 124 and the outer boundary 122.

In another example, at block 516, non-transparent material 128 may be deposited onto the optical window 100 and/or transition region 120 in accordance with the fill fraction assigned to each of a plurality of unit cells (virtually) defined within the transition region 120. In an example embodiment, the non-transparent material 128 may be deposited onto the optical window 100 and/or transition region 120 and then patterned based on the fill fraction assigned to each of a plurality of unit cells (virtually) defined within the transition region 120. For example, non-transparent material 128 may be deposited onto the optical window 100 and/or transition region 120 and/or patterned (e.g., via lithographic etching, lithographic liftoff-deposition, sputtering, one or more direct-write etching methods, and/or the like) in accordance with the respective fill fractions assigned to the unit cells within the transition region 120.

In another example, at block 518, fabricating the one or more features includes fabricating an array of metastructures 152 on the optical window 100 and/or on the transition region 120. For example, an array of pillars, holes, and/or other metastructures may be fabricated on the transition region 120 to form a metastructure on the transition region 120 that controls at least one optical transmission property of the optical window that evolves across the transition region 120. In various embodiments, the array of features may be fabricated using lithographic etching, lithographic liftoff-deposition, damascene processes, one or more direct-write etching methods, and/or the like. U.S. Application No. 63/562,327, filed Mar. 7, 2024, the content of which is incorporated herein by reference in its entirety, discloses some example techniques for fabricating an array of metastructures 152. In various embodiments, the metastructures are characterized by at least one dimension that is smaller than a wavelength that characterizes an optical beam that the optical window 100 is configured to transmit therethrough.

### Example Atomic and/or Quantum System

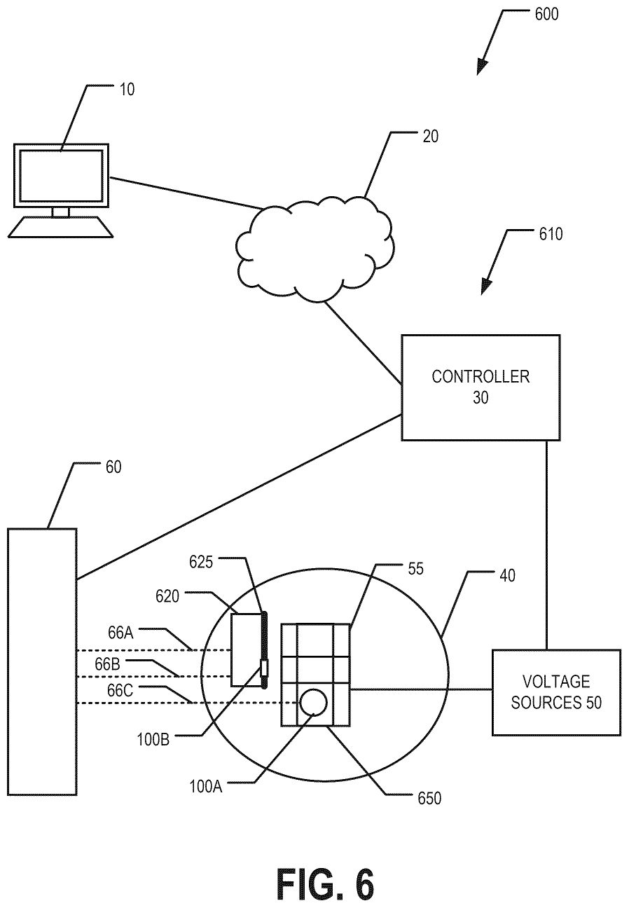

In various embodiments, the optical window 100 may be used to deliver optical beams to a respective target location of an atomic and/or quantum system. FIG. 6 provides a schematic diagram of an example atomic and/or quantum system that is a QCCD-based quantum computer system 600, in accordance with an example embodiment. In some embodiments, a quantum computer system 600 may include a PIC 620 having an opaque coating 625 on at least one surface thereof. An optical window 100B may be formed and/or defined in or through the opaque coating 625. In some embodiments, the quantum computer system 600 may include a plurality of electrodes 650 of an atomic and/or quantum object confinement apparatus 55 and an optical window 100A may be formed and/or defined in or through an electrode 650.

In various embodiments, the quantum computer system 600 comprises a computing entity 10 and a quantum computer 610. In various embodiments, a controller 30 of the quantum computer 610 may be in communication with the computing entity 10 via one or more wired and/or wireless networks 20. In various embodiments, the quantum computer 610 comprises the controller 30, a cryogenic and/or vacuum chamber 40 enclosing a confinement apparatus 55 (e.g., an ion trap and/or the like), one or more manipulation sources 60 (e.g., one or more laser systems), one or more beam delivery systems 66 (e.g., 66A, 66B, 66C) configured to deliver manipulation signals (e.g., optical beams such as laser beams) generated by the manipulation sources 60 to locations defined at least in part by the confinement apparatus 55, and/or the like. In various embodiments, the confinement apparatus 55 is a confinement apparatus configured to confine one or more atomic and/or quantum objects such as atoms, ions, molecules, quantum particles, and/or the like therein and the manipulation sources 60 are configured to provide manipulation signals to one or more portions of the confinement apparatus 55 via optical paths defined by the beam delivery system(s) 66. In various embodiments, the manipulation signals may be used to initialize one or more atomic and/or quantum objects (e.g., atoms, ions, molecules, quantum particles, and/or the like) into a qubit space, perform cooling operations, perform measurement operations, provide one or more gate signals, and/or the like. In various embodiments, the manipulation sources 60 comprise one or more laser systems configured to provide one or more manipulation signals (e.g., laser and/or optical beams and/or pulses) to one or more locations defined at least in part by the confinement apparatus 55 to enact one or more quantum gates (e.g., quantum logic gates) or other quantum operations. In various embodiments, the quantum gates may be one qubit gates, two qubit gates, and/or the like. In various embodiments, one or more gate signals may be provided to the one or more locations defined at least in part by the confinement apparatus 55 via beam delivery system(s) 66, which may include one or more optical windows 100 (e.g., 100A, 100B).

In various embodiments, a computing entity 10 is configured to allow a user to provide input to the quantum computer system 600 (e.g., via a user interface of the computing entity 10) and receive, view, and/or the like output from the quantum computer system 600. The computing entity 10 may be in communication with the controller 30 via one or more wired or wireless networks 20. For example, the computing entity 10 may be configured to provide quantum circuits to the controller 30 for execution by the quantum computer 610 and the controller 30 may provide the results of executing one or more quantum circuits to the computing entity 10.

In various embodiments, the controller 30 is configured to control the confinement apparatus 55, cooling and/or vacuum systems (not shown) controlling the temperature and pressure within the cryo and/or vacuum chamber 40, manipulation sources 60, and/or other components of the quantum computer 610 (e.g., an optical collection system configured for “reading” the output of the quantum computer). In various embodiments, the controller 30 is configured to control various components of the quantum computer 610 in accordance with executable instructions, command sets, and/or the like provided by the computing entity 10 and/or generated by the controller 30. In various embodiments, the controller 30 is configured to receive output from the quantum computer 610 (e.g., from an optical collection system) and provide the output and/or the result of processing the output to the computing entity 10.

### Technical Advantages

As an optical beam is transmitted through the optical window, the optical beam interacts with the edges of the optical window. This results in diffraction effects being present in the transmitted optical beam. In systems it is important to be able to precisely and accurately, in terms of position, spacings, mode profile, polarization, frequency, and/or phase, deliver one or more optical beams to target locations. For example, in atomic systems such as atomic clocks, Bose-Einstein condensate systems, trapped ion systems, QCCD-based quantum computers, and/or other atomic and/or quantum systems, precise and accurate laser beam delivery is important for various uses of the system, manipulating the system, and/or the like. However, the diffraction effects caused by the optical beam interacting with the edge of the optical window may introduce sufficient noise in the optical beam so as to degrade the fidelity of operations performed using the optical beam. Therefore, technical problems exist regarding providing an optical beam through an optical window. For example, technical challenges exist regarding providing an optical beam through an optical window for high fidelity atomic and/or quantum object interaction.

Various embodiments provide technical solutions to these technical problems. For example, in various embodiments, the edge of the optical window is apodized so as to reduce or prevent the presence of diffraction effects in optical beams that are transmitted through the optical window. In certain embodiments, an optical window is formed and/or defined in a non-transparent and/or optical opaque surface or structure (generally referred to as a non-transparent surface herein). A transition region of the optical window extends from an inner boundary disposed within the optical window and an outer boundary that is defined by and/or disposed at the boundary of the optical window. For example, at the perimeter of the optical window, the optical opacity of the optical window is substantially equal 100 percent. At least one optical transmission property of the optical window evolves across the transition region. For example, the opacity and/or transmissivity of the optical window may evolve across the transition region. In another example, an angle of deflection, polarization effect, relative phase delay, focus/divergence effect of the optical window on an optical beam passing through the window may evolve across the transition region. In various embodiments, the width of the transition region, in a plane of the optical window, is larger (possibly much much larger) than a wavelength that characterizes an optical beam that the optical window is configured to transmit there through. For example, in an embodiment where the optical beam to be transmitted through the optical window is characterized by 600 nm, the width of the transition region of the optical window is larger than 600 nm (e.g., 610 nm-1 micron). As a result, the optical beam being transmitted through the optical window does not experience the perimeter of the optical window as a hard edge and the diffractive effects are prevented and/or are not generated. Thus various embodiments provide technical improvements to the field of providing optical beams through optical windows with a high level of control over the optical properties of the optical beam, providing an optical beam through an optical window for high fidelity atomic and/or quantum object interaction, and/or systems that include optical windows.

### Exemplary Controller

In various embodiments, a quantum computer 610 comprises a controller 30 configured to control various elements of the quantum computer 610. In various embodiments, a controller 30 may be configured to cause a quantum computer 610 to perform various operations (e.g., computing operations such as gate operations, cooling operations, transport operations, qubit interaction operations, qubit measurement operations, leakage suppression operations, and/or the like). For example, the controller 30 may be configured to cause manipulation sources 60 to provide manipulation signals to objects (e.g., atoms, ions, molecules, quantum particles, and/or the like) confined and/or trapped within the confinement apparatus 55. For example, the controller 30 may be configured to cause the manipulation sources 60 to provide one or more laser and/or optical beams and/or pulses to one or more locations defined at least in part by the confinement apparatus 55 so as to enact, for example, one or more quantum gates, read a quantum state of an object, perform sympathetic laser cooling of an object, and/or the like. In various embodiments, the controller 30 may be configured to control a cryogenic system and/or vacuum system controlling the temperature and pressure within the cryogenic and/or vacuum chamber 40, manipulation sources 60, and/or other systems controlling the environmental conditions (e.g., temperature, humidity, pressure, and/or the like) within the cryogenic and/or vacuum chamber 40 and/or configured to manipulate and/or cause a controlled evolution of quantum states of one or more objects confined by the confinement apparatus 55.

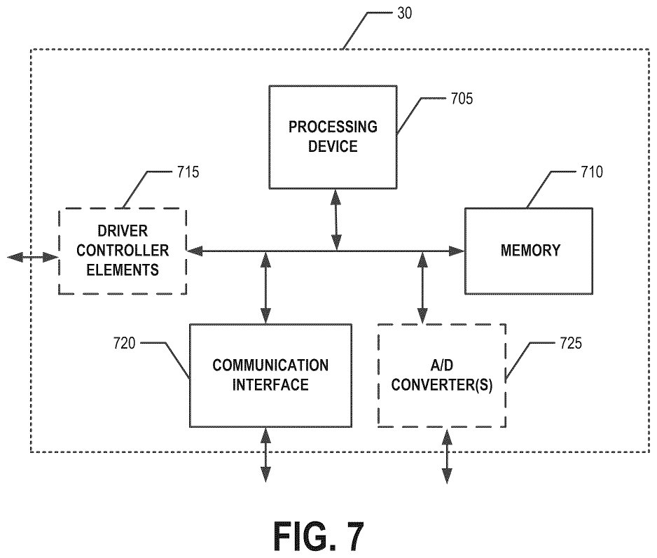

As shown in FIG. 7, in various embodiments, the controller 30 may comprise various controller elements including processing element(s) 705, memory 710, driver controller elements 715, a communication interface 720, analog-digital converter 725, and/or the like. For example, the processing element(s) 705 may comprise programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like, and/or controllers. The term circuitry may refer to an entirely hardware embodiment or a combination of hardware and computer program products. In an example embodiment, the processing element(s) 705 of the controller 30 comprises a clock and/or is in communication with a clock.

For example, the memory 710 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 710 may store qubit records corresponding the qubits of quantum computer (e.g., in a qubit record data store, qubit record database, qubit record table, and/or the like), a calibration table, an executable queue, computer program code (e.g., in a one or more computer languages, specialized controller language(s), and/or the like), and/or the like. In an example embodiment, execution of at least a portion of the computer program code stored in the memory 710 (e.g., by a processing element(s) 705) causes the controller 30 to perform one or more steps, operations, processes, procedures and/or the like described herein for tracking the phase of an atomic object within an atomic system and causing the adjustment of the phase of one or more manipulation sources and/or signal(s) generated thereby.

In various embodiments, the driver controller elements 715 may include one or more drivers and/or controller elements each configured to control one or more drivers. In various embodiments, the driver controller elements 715 may comprise drivers and/or driver controllers. For example, the driver controllers may be configured to cause one or more corresponding drivers to be operated in accordance with executable instructions, commands, and/or the like scheduled and executed by the controller 30 (e.g., by the processing element(s) 705). In various embodiments, the driver controller elements 215 may enable the controller 30 to operate a servo, manipulation sources 60 (e.g., laser systems), vacuum and/or cryogenic systems, and/or the like. In various embodiments, the drivers may be laser drivers; microwave drivers; vacuum component drivers; cryogenic and/or vacuum system component drivers; current drivers, and/or the like. For example, the drivers and/or driver controllers may be configured to cause a magnetic field generation device (e.g., comprising circuitry coupled to a voltage source (e.g., a current driver or voltage driver), permanent magnet(s), and/or a combination thereof) to generate a magnetic field having a particular direction and magnitude at one or more regions of and/or locations defined at least in part by the confinement apparatus 55. In various embodiments, a plurality of regions of and/or location defined at least in part by the confinement apparatus 55 (e.g., confinement apparatus zones) may be defined.

In various embodiments, the controller 30 comprises means for communicating and/or receiving signals from one or more optical receiver components such as cameras, MEMs cameras, CCD cameras, photodiodes, photomultiplier tubes, and/or the like. For example, the controller 30 may comprise one or more analog-digital converter element(s) 725 configured to receive signals from one or more optical receiver components, calibration sensors, and/or the like.

In various embodiments, the controller 30 may comprise a communication interface 720 for interfacing and/or communicating with a computing entity 10. For example, the controller 30 may comprise a communication interface 720 for receiving executable instructions, command sets, and/or the like from the computing entity 10 and providing output received from the quantum computer 610 (e.g., from an optical collection system) and/or the result of a processing the output to the computing entity 10. In various embodiments, the computing entity 10 and the controller 30 may communicate via a direct wired and/or wireless connection and/or one or more wired and/or wireless networks 20.

### Example Computing Entity

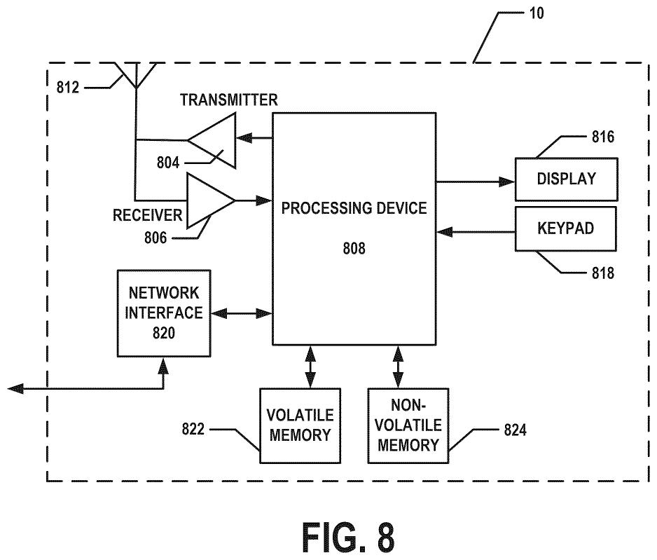

FIG. 8 provides an illustrative schematic diagram of an example computing entity 10 that can be used in conjunction with embodiments of the present invention. In various embodiments, a computing entity 10 is configured to allow a user to provide input to the quantum computer 610 (e.g., via a user interface of the computing entity 10) and receive, display, analyze, and/or the like output from the quantum computer 610. For example, a user may operate a computing entity 10 to generate and/or program a quantum algorithm and/or quantum circuit that may be provided such that the controller 30 may receive the quantum algorithm and/or quantum circuit and cause the quantum computer 610 to perform the quantum algorithm and/or quantum circuit.

As shown in FIG. 8, a computing entity 10 can include an antenna 812, a transmitter 804 (e.g., radio), a receiver 806 (e.g., radio), and a processing element 808 that provides signals to and receives signals from the transmitter 804 and receiver 806, respectively, which may collectively be referred to a transceiver. The signals provided to and received from the transmitter 804 and the receiver 806, respectively, may include signaling information/data in accordance with an air interface standard of applicable wireless systems to communicate with various entities, such as a controller 30, other computing entities 10, and/or the like. In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system. In various embodiments, the computing entity 10 includes one or more network interfaces 820 configured to communicate (e.g., with the controller 30 and/or one or more other computing entities 10) via one or more wired and/or wireless networks 20.

The computing entity 10 may also comprise a user interface device comprising one or more user input/output interfaces (e.g., a display 816 and/or speaker/speaker driver coupled to a processing element(s) 808 and a touch screen, keyboard, mouse, and/or microphone coupled to a processing element(s) 808). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 818 (hard or soft), a touch display, voice/speech or motion interfaces, scanners, readers, or other input device. In embodiments including a keypad 818, the keypad 818 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile memory or storage 822 and/or non-volatile memory or storage 824, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### CONCLUSION

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An optical window defined within a non-transparent surface, the optical window comprising:
a transition region defined proximate a perimeter of the optical window, wherein at least one optical transmission property of the optical window evolves across the transition region, wherein an opacity of the optical window at the perimeter is substantially equal to 100 percent,
wherein the optical window is configured for an optical beam transmitted therethrough to interact with a confined atomic or quantum object.

2. The optical window of claim 1, wherein the transition region is defined by an outer boundary that defines the perimeter of the optical window and an inner boundary located within the optical window, wherein the at least one optical transmission property of the optical window evolves from the inner boundary to the outer boundary.

3. The optical window of claim 2, wherein the at least one optical transmission property of the optical window evolves as a function of location between the inner boundary and the outer boundary.

4. The optical window of claim 2, wherein the at least one optical transmission property is opacity and the opacity of the optical window at the inner boundary is a minimal opacity that is less than 100 percent.

5. The optical window of claim 4, wherein the optical window comprises a sawtooth edge that comprises generally triangular-shaped segments of non-transparent material having a broad end located at the outer boundary and that extend from the broad end to a tip located between the outer boundary and the inner boundary or at the inner boundary.

6. The optical window of claim 4, wherein a patterned binary deposition of non-transparent material is present on the optical window between the inner boundary and the outer boundary and the patterned binary deposition of non-transparent material is configured such that a local fill fraction of non-transparent material increases from the inner boundary to the outer boundary.

7. The optical window of claim 6, wherein the respective local fill fraction increases from 0 at the inner boundary to 1 at the outer boundary.

8. The optical window of claim 4, further comprising a film disposed at least between the inner boundary and the outer boundary, the film having a minimum thickness at the inner boundary and a maximum thickness at the outer boundary.

9. The optical window of claim 8, wherein the opacity of the film increases as a thickness of the film increases.

10. The optical window of claim 4, wherein the inner boundary is defined by a distance from a center of the optical window that is greater than zero.

11. The optical window of claim 10, wherein a portion of the optical window disposed within the inner boundary is characterized by the minimal opacity.

12. The optical window of claim 1, wherein the at least one optical transmission property is an angle of deflection of the optical beam propagating through the optical window.

13. The optical window of claim 1, further comprising a metasurface disposed within the transition region, wherein the metasurface controls an evolution of the at least one optical transmission property.

14. The optical window of claim 1, wherein the non-transparent surface is a non-transparent coating on an exterior of a photonic integrated circuit (PIC) or a surface of an electrode.

15. The optical window of claim 1, wherein the transition region has a width in a plane defined by the optical window that is larger than a wavelength that characterizes an optical signal that the optical window is configured transmit therethrough.

16. A method for fabricating an optical window in a non-transparent surface, the method comprising:
forming one or more optical features on the optical window within a transition region disposed proximate a perimeter of the optical window, wherein an opacity of the optical window at the perimeter is substantially equal to 100%,
wherein the one or more optical features are configured to cause at least one optical transmission property of the optical window to evolve across the transition region.

17. The method of claim 16, wherein the one or more optical features are formed using at least one of lithographic etching, lift-off deposition, direct-write etching, or grey scale lithography.

18. The method of claim 16, wherein forming the one or more optical features comprises:
depositing a film between an inner boundary of the optical window and an outer boundary of the optical window, wherein the outer boundary of the optical window is defined by the perimeter of the optical window, the inner boundary is disposed within the optical window, and the opacity of the optical window at the inner boundary is a minimal opacity that is less than 100 percent; and
using greyscale lithography to pattern the film such that the film has a minimum thickness at the inner boundary and a maximum thickness at the outer boundary, wherein the opacity of the film increases within increasing thickness of the film.

19. The method of claim 16, wherein forming the one or more optical features comprises at least one of:
patterning a sawtooth edge that comprises generally triangular-shaped segments of non-transparent material having a broad end located at an outer boundary of the optical window and that extend from the broad end to a tip located between the outer boundary and an inner boundary of the optical window or at the inner boundary, wherein the outer boundary of the optical window is defined by the perimeter of the optical window, the inner boundary is disposed within the optical window, and the opacity of the optical window at the inner boundary is a minimal opacity that is less than 100 percent; or
patterning non-transparent material to fill a plurality of unit cells virtually defined within the transition region with respective fill fractions of non-transparent material, wherein the respective fill fractions are assigned to the plurality of unit cells as a function of locations of respective unit cells of the plurality of unit cells within the transition region.

20. The method of claim 16, wherein the one or more optical features form a metasurface within the transition region and the metasurface controls an evolution of the at least one optical transmission property.
